(19) United States
(12) Patent Application Publication
(10) Pub. No.: US 2021/0118606 A1
(43) Pub. Date: Apr. 22, 2021

(54) REACTOR

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Kazuhiro Inaba, Yokkaichi-shi, Mie (JP)

(21) Appl. No.: 16/981,847

(22) PCT Filed: Mar. 5, 2019
(86) PCT No.: PCT/JP2019/008584

§ 371 Date: Sep. 17, 2020

(30) Foreign Application Priority Data
Mar. 20, 2018 (JP) 2018-052985

(51) Int. Cl. H01F 27/28; H01F 27/255; H01F 41/02; H01F 41/06

(52) U.S. Cl. CPC H01F 27/2823; H01F 41/06; H01F 41/0246; H01F 27/255

(57) ABSTRACT

Provided is a reactor including: a coil including winding portions; and a magnetic core including inner core portions arranged inside of the winding portions and outer core portions arranged outside of the winding portions. The inner core portions are integrated objects with non-divided structures and include core through holes formed in a direction orthogonal to an axial direction of the winding portions, and openings on one side and openings on another side of the core through holes are both closed by the winding portions.

### CROSS-REFERENCE TO RELATED APPLICATIONS

This application is the U.S. national stage of PCT/JP2019/008584 filed on Mar. 5, 2019, which claims priority of Japanese Patent Application No. JP 2018-052985 filed on Mar. 20, 2018, the contents of which are incorporated herein.

### TECHNICAL FIELD

The present disclosure relates to a reactor.

### BACKGROUND

For example, JP 2017-135334A discloses a reactor that includes a coil having winding portions formed by winding a winding wire, and a magnetic core forming a closed magnetic circuit, the reactor being for use as a constituent component of a converter of a hybrid automobile, or the like. The magnetic core of the reactor can be divided into inner core portions arranged inside of the winding portions and outer core portions arranged outside of the winding portions.

The conventional reactor has room for improvement in terms of productivity. In a reactor for high-current applications, in order to suppress magnetic saturation of the magnetic core, the inner core portions are each constituted by multiple divided pieces and gaps are formed between the divided pieces. For this reason, there is a larger number of constituent components included in the inner core portions, and thus labor is required for preparing the multiple components and managing the components, whereby assembly of the inner core portions is complicated, and the productivity of the reactor is poor.

The present disclosure was made in view of the above-described circumstances, and one object thereof is to provide a reactor that has excellent productivity and is not likely to undergo magnetic saturation.

### SUMMARY

A reactor according to the present disclosure is a reactor including a coil including winding portions; and a magnetic core including inner core portions arranged inside of the winding portions and outer core portions arranged outside of the winding portions, in which the inner core portions are integrated objects with non-divided structures and include core through holes formed in a direction orthogonal to an axial direction of the winding portions, and openings on one side and openings on another side of the core through holes are both closed by the winding portions.

### Advantageous Effects of Disclosure

The reactor of the present disclosure is a reactor that has excellent productivity and is not likely to undergo magnetic saturation.

### BRIEF DESCRIPTION OF DRAWINGS

FIG. 1 is a perspective view of a reactor according to a first embodiment.

FIG. 2 is a schematic side view of the reactor shown in FIG. 1.

FIG. 3 is a plan view of a magnetic core included in the reactor shown in FIG. 1 viewed from above.

FIG. 4 is a schematic top view of an inner core portion including a core through hole with a shape other than that shown in FIG. 3.

FIG. 5 is a schematic top view of an inner core portion including a core through hole with a shape other than those shown in FIGS. 3 and 4.

FIG. 6 is a schematic front view of an interposed member included in the reactor shown in FIG. 1.

FIG. 7 is a diagram showing a state in which an inner core portion and an outer core portion are combined with the interposed member shown in FIG. 6.

FIG. 8 is an illustration showing a method for manufacturing the reactor according to the first embodiment.

### DETAILED DESCRIPTION OF PREFERRED EMBODIMENTS

First, embodiments of the present disclosure will be listed and described.

<1> A reactor according to an embodiment is a reactor including a coil including winding portions; and a magnetic core including inner core portions arranged inside of the winding portions and outer core portions arranged outside of the winding portions, in which the inner core portions are integrated objects with non-divided structures and include core through holes formed in a direction orthogonal to an axial direction of the winding portions, and openings on one side and openings on another side of the core through holes are both closed by the winding portions.

By making the inner core portions into integral objects with non-divided structures, the magnetic core can be formed by merely combining the inner core portions and the outer core portions, and the productivity of the reactor can be improved. Also, by providing the inner core portions with core through holes that are formed in a direction orthogonal to the axial direction of the winding portions of the coil, the core through holes can be used instead of gaps. As a result, by using the inner core portions having the core through holes that function as gaps, it is possible to suppress the overall relative permeability of the magnetic core from becoming too high, and it is possible to achieve a reactor that is not likely to undergo magnetic saturation.

<2> Examples of a mode of a reactor according to an embodiment can include a mode in which the core through holes each have an inner peripheral surface shape that is uniform in an axial direction of the core through hole, and a maximum width of each core through hole in a core width direction orthogonal to both the axial direction of the winding portion and the axial direction of the core through hole is 0.1 times or more and 0.7 times or less a width of the inner core portion in the core width direction.

By setting the above-described factor to 0.1 or more, it is possible to cause the core through holes to sufficiently function as gaps. Also, by setting the above-described factor to 0.7 or less, it is possible to sufficiently ensure the strength of the inner core portions even if the core through holes are provided.

<3> Examples of one mode of the reactor according to <2> above can include a mode in which the inner peripheral surface shapes of the core through holes are elongated hole shapes that extend in the core width direction.

Due to the inner peripheral surface shapes of the core through holes being elongated hole shapes that are elongated in the core width direction, it is possible to improve the function of the core through holes as gaps compared to the case where the inner surface shapes of the core through holes are elliptical shapes, or elongated hole shapes that are elongated in the axial direction of the winding portions.

<4> Examples of one mode of the reactor according to <3> above can include a mode in which intermediate portions in the core width direction of the inner peripheral surface shapes of the core through holes have constricted shapes.

Due to the intermediate portions of the core through holes having constricted shapes, a portion of the magnetic flux is more likely to pass through the constricted portions of the core through holes when the reactor is operated. As a result, it is possible to suppress the magnetic flux that passes through the substantial portions of the inner core portions away from the core through holes from becoming too large, and it is possible to suppress magnetic saturation from occurring in the substantial portions.

<5> Examples of a mode of a reactor according to an embodiment can include a mode in which inner resin portions filling spaces between the winding portions and the inner core portions are included, in which the inner resin portions enter the core through holes.

By forming the inner resin portions, it is possible to ensure insulation between the winding portions and the inner core portions and to strongly bond them. Moreover, due to the inner resin portions entering the core through holes, it is possible to even more strongly bond the winding portions and the inner core portions.

<6> Examples of one mode of the reactor according to <5> above can include a mode in which outer resin portions that cover at least part of the outer core portions and are connected to the inner resin portions are included.

By forming the outer resin portions, the outer core portions can be protected from the external environment. Also, due to the outer resin portions being connected to the inner resin portions, the outer core portions, the inner core portions, and the winding portions can be strongly bonded to each other.

<7> Examples of a mode of a reactor according to an embodiment can include a mode in which the relative permeability of the inner core portions is 5 or more and 50 or less, and the relative permeability of the outer core portions is 50 or more and 500 or less, and is greater than the relative permeability of the inner core portions.

By making the relative permeability of the outer core portions higher than the relative permeability of the inner core portions, magnetic flux leakage from between the two core portions can be reduced. In particular, by increasing the difference between the relative permeabilities of the two core portions, it is possible to more reliably reduce the magnetic flux leakage between the two core portions. Due to the above-described differences, it is possible to substantially eliminate the above-described magnetic flux leakage. Also, in the above-described mode, the relative permeability of the inner core portions is low, and therefore it is possible to suppress the relative permeability of the overall magnetic core from becoming too high.

<8> Examples of one mode of the reactor according to <7> above can include a mode in which the inner core portions are constituted by molded bodies of a composite material including a soft magnetic powder and resin.

With the molded body of the composite material, the relative permeability is likely to be reduced by adjusting the amount of the soft magnetic powder. For this reason, with the molded body of the composite material, it is easy to produce inner core portions in which the relative permeability satisfies the range described in <7> above.

<9> Examples of one mode of the reactor according to <8> above can include a mode in which the outer core portions are constituted by compressed powder molded bodies of a soft magnetic powder.

With the compressed powder molded body, it is possible to accurately produce the outer core portion. Also, with the compressed powder molded body that includes a fine soft magnetic powder, it is easy to produce outer core portions in which the relative permeability satisfies the range described in <7> above.

<10> Examples of one mode of a reactor according to any one of <7> to <9> above can include a mode in which, in a plan view of the magnetic core from above, when a ring-shaped virtual magnetic circuit including central axes of the inner core portions and analogous lines that pass through the centers of gravity of the outer core portions and are connected to the central axes, drawing shapes that are similar to outer boundary lines of the outer core portions, is defined, the percentage that the lengths of the central axes occupy in the length of the virtual magnetic circuit is 50% or less.

As described before, by making the relative permeability of the inner core portions lower than the relative permeability of the outer core portions, it is possible to obtain an effect of suppressing the overall relative permeability of the magnetic core from becoming too high, and suppressing magnetic saturation of the magnetic core. However, when a virtual magnetic circuit imitating a magnetic circuit, which is a main path through which a magnetic circuit passes, is defined, if the lengths that the central axes of the inner core portions (same as the axial lengths of the inner core portions) occupy in the length of the virtual magnetic circuit is short, the above-described effect of suppressing the magnetic saturation is limited. In particular, in the case of using a conventional magnetic core using an inner core portion that does not include a core through hole that functions as a gap, if the percentage that the lengths of the central axes of the inner core portions occupy in the length of the virtual magnetic circuit is 50% or less, the effect of suppressing magnetic saturation cannot be sufficiently obtained. In contrast to this, in the case of using the magnetic core of the embodiment using the inner core portions including the core through holes that function as gaps, even if the percentage that the lengths of the central axes of the inner core portions occupy in the length of the virtual magnetic circuit is 50% or less, it is possible to sufficiently obtain the effect of suppressing magnetic saturation.

A reactor according to embodiments of the present disclosure will be described below with reference to the drawings. Components with the same name are given the same reference numeral. Note that the present disclosure is not limited to the configurations described in the embodiments. The present disclosure is defined by the scope of the claims, and all modifications that are equivalent to or within the scope of the claims are included.

### First Embodiment

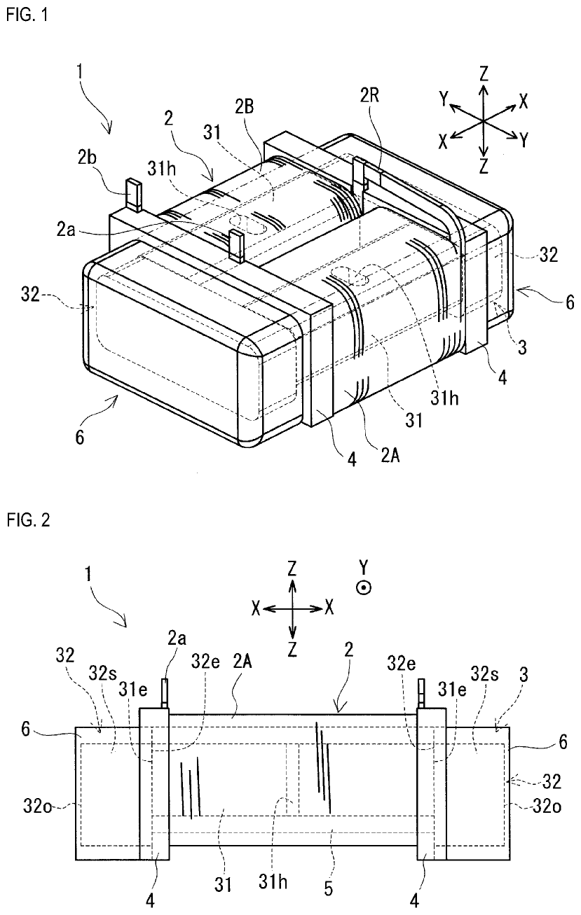

In a first embodiment, a configuration of a reactor 1 will be described with reference to FIGS. 1 to 8. The reactor 1 shown in FIG. 1 is constituted by combining a coil 2, a magnetic core 3, and interposed members 4. The reactor 1 further includes inner resin portions 5 (see FIG. 2) that are arranged inside of winding portions 2A and 2B included in the coil 2 and cover the inner core portions 31 constituting part of the magnetic core 3, and outer resin portions 6 that cover outer core portions 32 constituting part of the magnetic core 3. One example of a feature of the reactor 1 is that core through holes 31h are formed in the inner core portions 31. Hereinafter, the configurations included in the reactor 1 will be described in detail, and the shapes, positions, function, and the like of core through holes 31h will be described in detail in an itemized manner.

### Coil

As shown in FIG. 1, the coil 2 of the present embodiment includes a pair of winding portions 2A and 2B and a coupling portion 2R for coupling the winding portions 2A and 2B. The winding portions 2A and 2B are formed in a hollow cylindrical shape and are wound the same number of times in the same winding direction. The axial directions of the winding portions 2A and 2B are placed side by side with the axial directions parallel with one another. In the present embodiment, the coil 2 is made from one winding wire. However, the coil 2 may also be made by coupling the winding portions 2A and 2B formed from separate winding wires. Gaps between adjacent turns of the above-described winding portions 2A and 2B are approximately equivalent. That is, since the winding portions 2A and 2B include a certain coil pitch and there is no portion at which the coil pitch is locally wide, the winding portions 2A and 2B can be easily produced. It is preferable that there are substantially zero gaps between the turns.

Here, the directions in the reactor 1 are defined with reference to the coil 2. Firstly, the direction along the axial direction of the winding portions 2A and 2B of the coil 2 is defined as the X direction. The direction that is orthogonal to the X direction and conforms to the direction in which the winding portions 2A and 2B are arranged side by side is defined as the Y direction. Also, the direction intersecting both the X direction and the Y direction is defined as the Z direction.

The winding portions 2A and 2B of the present embodiment are formed in a rectangular prism-like shape. The winding portions 2A and 2B with a rectangular prism-like shape are winding portions with a quadrangular (including a square) end surface shape with rounded corners. The winding portions 2A and 2B may of course also be formed in a cylindrical shape. A winding portion with a cylindrical shape is a winding portion with a closed curve (such as an ellipse, a perfect circle, or a race track shape) end surface shape.

The coil 2 including the winding portions 2A and 2B may be a coated wire including a conductor, such as a rectangular wire or a round wire, made of an electrically conductive material, such as copper, aluminum, magnesium, or an alloy thereof, and an insulating coating made of an insulating material covering the outer circumference of the conductor. In the present embodiment, the winding portions 2A and 2B are formed by edgewise winding a coated rectangular wire including a conductor made of a copper rectangular wire (winding wire) and an insulating coating of enamel (polyamideimide being a representative example).

End portions 2a and 2b of the coil 2 extend out from the winding portions 2A and 2B for connection with a terminal member (not shown). The end portions 2a and 2b have the insulating coating of enamel, for example, removed. The coil 2 connects, via the terminal member, to an external device such as a power supply for supplying electric power to the coil 2.

### Magnetic Core

As shown in FIGS. 1 and 2, the magnetic core 3 includes inner core portions 31 arranged inside of the winding portions 2A, 2B and outer core portions 32 that form a closed magnetic circuit with the inner core portions 31.

### Inner Core Portion

The inner core portions 31 are portions of the magnetic core 3 that are aligned with the axial direction (X-direction) of the winding portions 2A and 2B of the coil 2. In the present embodiment, as shown in FIG. 2, the end portions of the portions of the magnetic core 3 that are aligned with the axial direction of the winding portions 2A and 2B project out from the end surfaces of the winding portions 2A and 2B (see the position of an end surface 31e of the inner core portion 31). The portion that projects out is a portion of the inner core portion 31.

The shape of the inner core portion 31 is not particularly limited as long as it is a shape that conforms to the inner shape of the winding portion 2A (2B).

The inner core portions 31 of the present example are approximately cuboid-shaped. Also, the inner core portions 31 of the present example are integrated objects with a non-divided structure, and include the core through holes 31h.

### Core Through Holes

The core through holes 31h are holes formed through the inner core portions 31 in the height direction (Z direction) of the reactor 1, which is orthogonal to the axial direction (X direction) of the winding portions 2A and 2B, and function as gaps of the inner core portions 31. The core through holes 31h need only be holes that extend along the YZ plane, which is orthogonal to the X direction, and for example, can also be holes formed through the inner core portions 31 in the direction in which the winding portions 2A and 2B are arranged side by side (Y direction). The core through holes 31h preferably have inner peripheral surface shapes that are uniform in the axial direction (Z direction), whereby it is possible to stabilize the function of the core through holes 31h as gaps.

In the present example, one core through hole 31h is provided at the central position in the axial direction of the inner core portion 31, but the number of core through holes 31h is not particularly limited. Although multiple core through holes 31h may also be provided in one inner core portion 31, if the number of core through holes 31h is too high, there is a risk that the strength and the magnetic properties of the inner core portion 31 will decrease. In view of this, if multiple core through holes 31h are to be provided in the inner core portion 31, for example, it is possible to provide one core through hole 31h in each of the vicinity of the end surface 31e on one end side in the axial direction of the inner core portion 31 and the vicinity of the end portion 31e on the other end side. As long as no problems occur in the strength and magnetic properties of the inner core portion 31, the core through hole 31h can be provided freely. For example, multiple core through holes 31h can also be arranged so as to intersect each other in a view in the X direction.

The openings on one side and the openings on the other side of the core through holes 31h are closed by the winding portions 2A and 2B. This indicates a state in which the turns of the winding portions 2A and 2B overlap in 50% or more of the area of the openings in a view of the openings of the core through holes 31h in the axial direction from the outer periphery of the winding portions 2A and 2B. The overlapping area is preferably large, and for example, can be 60% or more, and furthermore, 70% or more. The overlapping area being large means that the gaps between the turns of the winding portions 2A and 2B are small, and thus the reactor 1 can be made compact in the X direction, and it is possible to suppress the resin from leaking to the outside of the winding portions 2A and 2B when resin fills the interiors of the winding portions 2A and 2B as will be described later. From the perspective of suppressing resin leakage, the above-described overlapping area is preferably 90% or more, and more preferably, 95% or more. Due to the core through holes 31h being covered by the winding portions 2A and 2B, loss resulting from magnetic flux leakage can be suppressed.

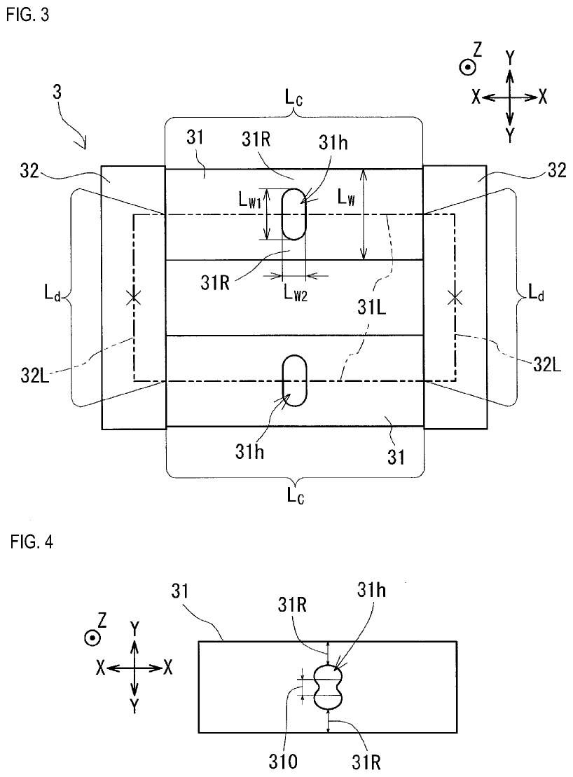

As shown in FIG. 3, the inner peripheral surface shapes of the core through holes 31h (same as the shapes of the opening portions) are preferably elongated hole shapes that extend in a core width direction (Y direction). Due to the inner peripheral surface shapes of the core through holes 31h being longer in the core width direction, the function of the core through holes 31h as gaps can be improved. Examples of the elongated hole shape can include a rectangular shape, an elliptical shape, a racetrack shape that is constituted by a pair of straight line portions that extend in the core width direction shown in FIG. 3, a circular arc portion that connects the ends on one side of the two straight portions, and a circular arc portion that connects the ends on the other side of the two straight portions, and the like. In particular, with the racetrack-shaped core through holes 31h, it is possible to use inner core portions 31 in which the flow of the magnetic flux that bypasses the core through holes 31h is smoother and the magnetic properties are excellent.

A maximum width L_{W1} in the core width direction (Y direction) of the core through hole 31h is preferably 0.1 times or more and 0.7 times or less of a width L_{W} of the inner core portion 31 in the core width direction. By making the above-described factor 0.1 times or more, it is possible to cause the core through holes 31h to sufficiently function as gaps. Also, by setting the above-described factor to 0.7 times or less, even if the core through holes 31h are provided, the width of the substantial portion 31R of the inner core portion 31 on the outer side in the width direction can be sufficiently ensured, and therefore the mechanical strength of the inner core portion 31 can be sufficiently ensured. A more preferable factor is 0.2 times or more and 0.6 times or less, and an even more preferable factor is 0.3 times or more and 0.5 times or less. Here, in the case of using a hole in which the axial direction of the core through hole 31h extends in the Y direction, the Z direction is the core width direction.

A maximum width Lw2 in the axial direction (X direction) of the winding portions 2A and 2B of the core through hole 31h is not particularly limited. The maximum width Lw2 in the X direction of the core through hole 31h can be selected as needed according to the degree to which the function as gaps required of the core through holes 31h is to be set. Here, the openings on one side and the openings on the other side of the core through holes 31h both need to be closed by the winding portions 2A and 2B. In order to achieve this, for example, a case is given in which the gap between the adjacent turns of the winding portions 2A and 2B (or the coil pitch) is 10% or less (or 10% or less), and furthermore, 5% or less (or 5% or less) of the maximum width L_{W2} in the X direction of the core through hole 31h.

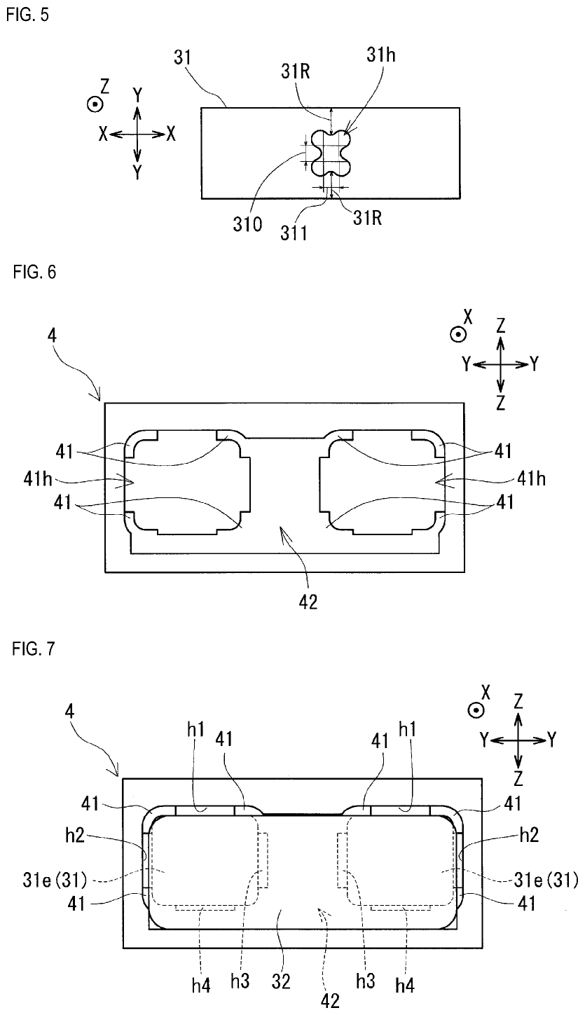

In addition to the core through holes 31h having an elongated hole shape, as shown in FIGS. 4 and 5, it is also possible to give the intermediate portions 310 in the core width direction (Y direction) of the inner peripheral surface shapes of the core through holes 31h a constricted shape. Due to the intermediate portions 310 of the core through holes 31h having a constricted shape, part of the magnetic flux at the time of operating the reactor 1 (FIG. 1) is more likely to pass through the constricted locations (intermediate portions 310) of the core through holes 31h. As a result, it is possible to prevent the number of magnetic fluxes passing through the substantial portions 31R of the inner core portions 31 away from the core through holes 31h from becoming excessively high, and it is possible to suppress magnetic saturation of the substantial portions 31R. Furthermore, as shown in FIG. 5, the intermediate portions 311 in the X direction in the inner peripheral surface shapes of the core through holes 31h can also have a constricted shape. With this kind of shape, the substantial portions 31R are larger at the positions of the intermediate portions 311, and therefore it is easy to suppress magnetic saturation of the substantial portions 31R.

### Outer Core Portion

The outer core portions 32 shown in FIG. 1 are portions of the magnetic core 3 that are arranged outside of the winding portions 2A and 2B. The shape of the outer core portions 32 is not particularly limited as long as it is a shape that connects the end portions of the pair of inner core portions 31. The outer core portions 32 of the present example are approximately cuboid-shaped. As shown in FIG. 2, the outer core portions 32 include coil opposing surfaces 32e that oppose the end surfaces of the winding portions 2A and 2B of the coil 2, outer surfaces 32o on the sides opposite to the coil opposing surfaces 32e, and peripheral surfaces 32s. As shown in FIGS. 2 and 3, the coil opposing surfaces 32e of the outer core portions 32 and the end surfaces 31e of the inner core portions 31 are in contact with each other or are substantially in contact with each other via adhesive.

### Magnetic Property, Material, Etc.

The relative permeability of the inner core portions 31 is preferably 5 or more and 50 or less, and the relative permeability of the outer core portions 32 is preferably 50 or more and 500 or less, and is preferably higher than the relative permeability of the inner core portions 31. The relative permeability of the inner core portions 31 can be further set to 10 or more and 45 or less, 15 or more and 40 or less, and 20 or more and 35 or less. On the other hand, the relative permeability of the outer core portions 32 can further be 80 or more, 100 or more, 150 or more, and 180 or more. By making the relative permeability of the outer core portions 32 higher than the relative permeability of the inner core portions 31, magnetic flux leakage between the two core portions 31 and 32 can be reduced. In particular, by increasing the difference between the relative permeabilities of the two core portions 31 and 32, for example, by setting the relative permeability of the outer core portions 32 to at least two times the relative permeability of the inner core portions 31, the magnetic flux leakage between the two core portions 31 and 32 can be substantially eliminated. Also, in the above-described embodiment, the relative permeability of the inner core portions 31 is lower compared to the relative permeability of the outer core portions 32, and therefore it is possible to suppress the overall relative permeability of the magnetic core 3 from becoming excessively high, and thus it is possible to achieve a magnetic core 3 with a gapless structure.

The inner core portions 31 and the outer core portions 32 can be constituted by compressed powder molded bodies formed by compression molding a raw material powder including a soft magnetic powder, or molded bodies of a composite material obtained by solidifying a mixture of a soft magnetic powder and unsolidified resin. The soft magnetic powder of the compressed powder molded body is an aggregate of soft magnetic particles constituted by an iron group metal such as iron, an alloy thereof (Fe—Si alloy, Fe—Ni alloy, etc.), or the like.

An insulating covering constituted by a phosphate or the like may also be formed on the surfaces of the soft magnetic particles. The raw material powder may also include a lubricating material or the like.

The same materials that can be used in the compressed powder molded body can be used in the soft magnetic powder of the composite material.

Examples of the resin included in the composite material include thermosetting resins, thermoplastic resins, room temperature curable resins, low temperature curable resins, and the like. Examples of thermosetting resins include unsaturated polyester resins, epoxy resins, urethane resins, silicone resins, and the like. Examples of thermoplastic resins include polyphenylene sulfide (PPS) resins, polytetrafluoroethylene (PTFE) resins, liquid crystal polymers (LCP), polyamide (PA) resins such as nylon 6 or nylon 66, polybutylene terephthalate (PBT) resins, acrylonitrile butadiene styrene (ABS) resins, and the like. Alternatively, a bulk molding compound (BMC), a millable silicone rubber, a millable urethane rubber, or the like including calcium carbonate and/or glass fiber mixed with unsaturated polyester may also be used. The composite material described above, in addition to the soft magnetic powder and the resin, may include a non-magnetic, non-metal powder (filler), such as alumina, silica, or the like, to further enhance heat dissipation. The amount of the non-magnetic, non-metal powder may be from 0.2 mass % to 20 mass %, from 0.3 mass % to 15 mass %, or from 0.5 mass % to 10 mass %, for example.

The amount of the soft magnetic powder in the composite material may be from 30 volume % to 80 volume %, for example. From the perspective of enhancing the saturated magnetic flux density and the heat dissipation, the amount of soft magnetic powder may be 50 volume % or greater, 60 volume % or greater, or 70 volume % or greater. From the perspective of enhancing the fluidity in the manufacturing process, the amount of soft magnetic powder is preferably 75 volume % or less. In the molded body of the composite material, the relative permeability is easily reduced, as long as the filling ratio of the soft magnetic powder is set to be low. For this reason, the molded body of the composite material is suitable for producing an inner core portion 31 in which the relative permeability satisfies 5 or more and 50 or less. In the present example, the inner core portion 31 is constituted by a molded body of a composite material and has a relative permeability of 20.

With the compressed powder molded body, the content of the soft magnetic powder is easily made higher than that of the molded body of the composite material (e.g., greater than 80 vol %, and furthermore 85 vol % or more), and a core piece with a higher saturation magnetic flux density and relative permeability is likely to be obtained. For this reason, the compressed power molded body is suitable for producing an outer core portion 32 in which the relative permeability is 50 or more and 500 or less. In the present example, the outer core portion 32 is constituted by a compressed powder molded body and has a relative permeability of 200.

### Proportions of Inner Core Portions and Outer Core Portions

By forming the core through holes 31h in the inner core portions 31, the percentage that the lengths in the axial direction of the inner core portions 31 (lengths of the central axes 31L) occupy in the length of the virtual magnetic circuit indicated by a two-dot chain line in FIG. 3 can be set to 50% or less. A virtual magnetic circuit schematically indicates the main path through which the magnetic circuit passes, and is obtained by connecting the central axes 31L of the inner core portions 31 and analogous lines 32L of the outer core portions 32 into a ring shape in a plan view of the magnetic core 3 from above. The central axis 31L is a line that extends along the axial direction of the inner core portion 31 through the center in the width direction of the inner core portion 31. On the other hand, the analogous line 32L is a line that passes through the center of gravity (see the X mark in FIG. 3) of the outer core portion 32 in a plan view and is connected to the central axes 31L, drawing a shape that is similar to the outer boundary line of the outer core portion 32. The above-described center of gravity is not a mass center of gravity, but is the center of gravity of the planar surface area of the outer core portion 32 in a plan view. The outer boundary line is the part of the boundary line of the outer core portion 32 excluding the lines corresponding to the inner core portion 31. The actual magnetic circuit has a racetrack shape in which the corner portions of the analogous lines 32L are curved, but it may be thought that there is not such a significant difference between the length of the actual magnetic circuit and the virtual magnetic circuit. For this reason, the percentage that the central axes 31L occupy in the length of the virtual magnetic circuit being defined means that the percentage that the lengths in the axial direction of the inner core portions 31 occupy in the length of the magnetic circuit is defined. In the case of the present example, when the length of the central axis 31L (axial direction length) of the inner core portion 31 is set to L_{C} and the length of the analogous line 32L is set to L_{d}, the percentage that the lengths of the central axes 31L of the inner core portions 31 occupy in the length of the virtual magnetic circuit is indicated by [(2×L_{C})/(2×L_{d}+2×L_{C})]×100.

By shortening the axial direction length L_{C} of the inner core portion 31 occupying the length of the virtual magnetic circuit, the reactor 1 can be made compact. By contrast, the effect of suppressing magnetic saturation of the magnetic core 3 obtained by lowering the relative permeability of the inner core portions 31 relative to the relative permeability of the outer core portions 32 is less likely to be obtained. In particular, in the case of using a conventional magnetic core using inner core portions that do not include core through holes that function as gaps, if the above-described percentage is 50% or less, the effect of suppressing magnetic saturation cannot be sufficiently obtained. In contrast to this, with the magnetic core 3 of the present example using inner core portions 31 that include core through holes 31h that function as gaps, even if the above-described percentage is 50% or less, and furthermore 40% or less, the effect of suppressing magnetic saturation can be sufficiently obtained. On the other hand, when the above-described percentage is too low, the effect of suppressing magnetic saturation is less likely to be obtained even if the core through holes 31h are present in the inner core portions 31, and therefore it is preferable that the above-described percentage is 30% or more.

### Interposed Member

The reactor 1 of the present example shown in FIG. 1 further includes the interposed members 4 that are interposed between the coil 2 and the magnetic core 3. The interposed member 4 is typically composed of an insulating material and functions as an insulating member between the coil 2 and the magnetic core 3, and a member for positioning the inner core portion 31 and the outer core portion 32 with respect to the winding portions 2A and 2B. The interposed member 4 of this example is a rectangular frame-shaped member, and functions also as a member that forms a flow path of resin that fills the winding portions 2A and 2B. Although the interposed member 4 is not essential, by using the interposed member 4, ensurement of the above-described insulation and positioning can be easily performed.

Hereinafter, the interposed member 4 of the present example will be described with reference to FIGS. 6 and 7. FIG. 6 is a front view of the interposed member 4 from one side on which the outer core portion 32 (FIG. 1) is arranged, and the other side on which the winding portions 2A and 2B (FIG. 1) is on the other side and is not visible. FIG. 7 is a diagram showing a state in which the inner core portions 31 and one outer core portion 32 are attached to the interposed member 4 shown in FIG. 6.

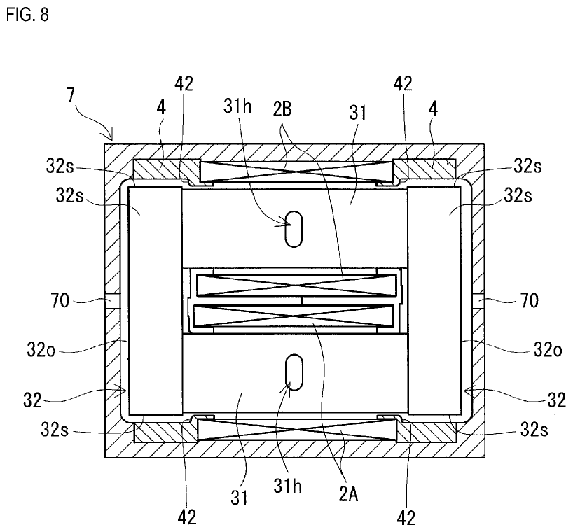

As shown in FIG. 6, the interposed member 4 includes: a pair of through holes 41h, multiple support portions 41 that are provided on each of the through holes 41h, a coil accommodation portion (not shown), and a core accommodation portion 42. The through holes 41h are formed in the thickness direction of the interposed member 4, and the inner core portion 31 is inserted through the through holes 41h as shown in FIG. 7. The inner peripheral surfaces forming the through holes 41h substantially match the inner peripheral surfaces of the winding portions 2A and 2B (FIG. 1). The support portions 41 protrude partially from the inner peripheral surfaces of the through holes 41h and support the four corners of each of the inner core portions 31. The coil accommodation portion is provided on the one surface side of the interposed member 4 that cannot be seen in the drawing, and the end surfaces of the winding portions 2A and 2B (FIG. 1) and the vicinities thereof are fit therein. The core accommodation portion 42 is formed due to portions on one surface side of the interposed member 4 being recessed in the thickness direction, and the coil opposing surfaces 32e of the outer core portions 32 and the vicinity thereof are fit therein (see FIG. 2 as well). The end surfaces 31e (FIG. 7) of the inner core portions 31 fit into the through holes 41h of the interposed member 4 protrude from the bottom surfaces of the core accommodation portions 42 (see also later-described FIG. 8). For this reason, the outer core portions 32 fit into the core accommodation portion 42 are spaced apart from the bottom portions of the core accommodation portions 42. The gaps that are formed due to the outer core portions 32 and the bottom portions of the core accommodation portions 42 being spaced apart from each other serve as flow paths of resin, as will be described later.

As shown in FIG. 7, in the interposed member 4 of the present example, in a state in which the winding portions 2A and 2B are fit into the coil accommodation portion and the inner core portions 31 are inserted into the through holes 41h, the four resin filling holes h1, h2, h3, and h4 are formed which are in communication with the gaps between the winding portions 2A and 2B and the inner core portions 31. More specifically, the resin filling holes h1 are formed between the upper edges of the end surfaces 31e of the inner core portions 31 and the inner peripheral surfaces of the through holes 41h (FIG. 6), and the resin filling holes h2 are formed between the outer edges of the above-described end surfaces 31e and the inner peripheral surfaces of the through holes 41h. Also, the resin filling holes h3 are formed between the inner edges of the above-described end surfaces 31e and the inner peripheral surfaces of the through holes 41h, and the resin filling holes h4 are formed between the lower edges of the above-described end surfaces 31e and the inner peripheral surfaces of the through holes 41h. Although the resin filling holes h1 and h2 are not covered by the outer core portion 32, the resin filling holes h3 and h4 are covered by the outer core portion 32.

The interposed member 4 can be constituted by a thermoplastic resin such as polyphenylene sulfide (PPS) resin, polytetrafluoroethylene (PTFE) resin, liquid crystal polymer (LCP), polyamide (PA) resin such as nylon 6 or nylon 66, polybutylene terephthalate (PBT) resin, or acrylonitrile butadiene styrene (ABS) resin. In addition, the interposed member 4 can be formed using a thermosetting resin or the like such as unsaturated polyester resin, epoxy resin, urethane resin, or silicone resin. The heat dissipation ability of the interposed member 4 may also be improved by including ceramic filler in these resins. For example, a non-magnetic powder such as alumina or silica can be used as the ceramic filler.

### Inner Resin Portion

As shown in FIG. 2, the inner resin portion 5 is arranged inside of the winding portion 2A (the same applies to the winding portion 2B (not shown) as well), and joins the inner peripheral surface of the winding portion 2A and the outer peripheral surface of the inner core portion 31. By forming the inner resin portions 5, the insulation between the winding portions 2A and 2B and the inner core portions 31 can be ensured while making the bonds therebetween strong. The inner resin portion 5 remains inside of the winding portion 2A without spanning between the inner peripheral surface and the outer peripheral surface of the winding portion 2A. That is, as shown in FIG. 1, the outer peripheral surfaces of the winding portions 2A and 2B are exposed to the outside without being covered by resin.

When the winding portions 2A and 2B are filled, inner resin portions 5 enter the core through holes 31h of the inner core portions 31. The bonds between the winding portions 2A and 2B and the inner core portions 31 can be made even stronger by using the inner resin portions 5 that have entered the core through holes 31h as anchors.

For example, a thermosetting resin such as epoxy resin, phenol resin, silicone resin, or urethane resin, a thermoplastic resin such as PPS resin, PA resin, polyimide resin, or fluororesin, a room-temperature-curable resin, or a low-temperature-curable resin can be used as the inner resin portion 5. The heat dissipating property of the inner resin portion 5 may also be improved by including a ceramic filler such as alumina or silica in these resins.

### Outer Resin Portion

As shown in FIGS. 1 and 2, the outer resin portions 6 are arranged so as to cover the entire outer peripheries of the outer core portions 32 exposed from the interposed members 4, fix the outer core portions 32 to the interposed members 4, and protect the outer core portions 32 from the external environment. The outer resin portions 6 of the present example are connected to the inner resin portions 5. That is, the outer resin portions 6 and the inner resin portions 5 are both formed at the same time using the same resin. Due to the outer resin portions 6 being connected to the inner resin portions 5, the outer core portions 32, the inner core portions 31, and the winding portions 2A and 2B can be bonded together strongly.

The outer resin portions 6 of the present example are provided on the sides of the interposed members 4 on which the outer core portions 32 is arranged, and do not reach the outer peripheral surfaces of the winding portions 2A and 2B.

In view of the function of the outer resin portions 6 of performing fixing and protection of the outer core portions 32, it is sufficient that the ranges in which the outer resin portions 6 are formed are as illustrated, and it can be said that the ranges are preferable in that the amount of resin used can be reduced. Of course, unlike the illustrated example, the outer resin portions 6 may also reach the winding portions 2A and 2B.

### Modes of Use

The reactor 1 of the present embodiment can be used in a constituent member of a power conversion device such as a bidirectional DC-DC converter installed in an electric vehicle, such as a hybrid vehicle, electric vehicle, or a fuel cell vehicle. The reactor 1 of the present embodiment can be used while submerged in a liquid refrigerant. The liquid refrigerant is not particularly limited. However, an automatic transmission fluid (ATF) or the like can be used as the liquid refrigerant in a case in which the reactor 1 is used in a hybrid vehicle. Alternatively, fluorine-based inert liquids such as Fluorinert (trade name); fluorocarbon-based refrigerants, such as HCFC-123 and HFC-134a; alcohol-based refrigerants, such as methanol and alcohol; ketone-based refrigerants such as acetone; and the like can be used as the liquid refrigerant. In the reactor 1 of the present example, due to being exposed to the outside of the winding portions 2A and 2B, if the reactor 1 is cooled using a cooling medium such as a liquid refrigerant, the winding portions 2A and 2B come into direct contact with the cooling medium, and therefore the reactor 1 of the present example has an excellent heat dissipation ability.

### Effects

In the reactor 1 of the present example, the inner core portions 31 are integrated objects with a non-divided structure, and therefore the magnetic core 3 can be produced more easily than in the mode in which they are formed by combining multiple divided pieces. In the present example, the magnetic core 3 can be produced by merely combining the pair of inner core portions 31 and the pair of outer core portions 32, and therefore the productivity of the reactor 1 including production of the magnetic core 3 can be improved.

Also, since the core through holes 31h that function as gaps are formed in the inner core portions 31 of the present disclosure, it is possible to suppress the overall relative permeability of the magnetic core 3 including the inner core portions 31 from becoming too high. As a result, in usage of the reactor 1 at large currents, the magnetic core 3 is not likely to undergo magnetic saturation.

### Reactor Manufacturing Method

Next, one example of a method for manufacturing a reactor for manufacturing a reactor 1 according to a first embodiment will be described. The reactor manufacturing method mainly includes the following steps.
Coil production step
Attachment step
Filling step
Curing step

### Coil Production Step

In this step, a winding wire is prepared and a coil 2 is produced by winding portions of the winding wire. A known winding machine can be used to wind the winding wire. A thermally welded resin layer is formed on the outer surface of the winding wire, and after the winding wire is wound to form the winding portions 2A and 2B, the coil 2 may also be subjected to a heat treatment. In this case, the turns of the winding portions 2A and 2B can be integrated, and thus a later-described filling step is easier to perform.

### Attachment Step

In this step, the coil 2, the magnetic core 3, and the interposed member 4 are combined with each other. For example, the inner core portions 31 are arranged inside of the winding portions 2A and 2B, and a first set obtained by bringing the pair of interposed members 4 into contact with the end surfaces on one end side and the end surfaces on the other end side in the axial direction of the winding portions 2A and 2B is produced. Then, a second set obtained by sandwiching the first set with the pair of outer core portions 32 is produced. The end surfaces 31e of the inner core portions 31 and the coil opposing surfaces 32e of the outer core portions 32 can be bonded to each other using an adhesive or the like. In the present example, the inner core portions 31 are integrated objects with non-divided structures, and therefore the attachment step can be performed easily.

In view of this, as shown in FIG. 7, when the second set is viewed from the outside of the outer core portion 32, the resin filling holes h1 and h2 for filling the winding portions 2A and 2B with the resin are formed on the side edges and the upper edges of the outer core portions 32. Also, although covered by the outer core portions 32, the resin filling holes h3 and h4 are formed also on the inner side edges and the lower side edges of the inner core portions 31.

### Filling Step

In the filling step, the winding portions 2A and 2B of the second set are filled with resin. In the present example, as shown in FIG. 8, the second set is arranged in a mold 7, and injection processing for injecting resin into the mold 7 is performed.

The injection of the resin is performed through two resin injection holes 70 of the mold 7. The resin injection holes 70 are provided at positions corresponding to the outer surfaces 32o of the outer core portion 32, and the injection of the resin is performed from the outer sides (outer surface 32o sides) of the outer core portions 32. The resin filling the mold 7 covers the outer peripheries of the outer core portions 32, surrounds the outer peripheral surfaces of the outer core portions 32, and flows into the winding portions 2A and 2B via the resin filling holes h1 and h2 shown in FIG. 7. Also, the resin covering the outer core portions 32 flows into the gaps between the coil opposing surfaces 32e (FIG. 2, etc.) of the outer core portions 32 and the bottom portions of the core accommodation portions 42 of the interposed members 4, and further flows into the winding portions 2A and 2B via the resin filling holes h3 and h4 of FIG. 7 from the gaps. The resin that has flowed into the winding portions 2A and 2B also flows into the core through holes 31h and completely fills in the core through holes 31h.

### Curing Step

In the curing step, the resin is cured through heat treatment or the like. As shown in FIG. 2, the inner resin portions 5 are the portions of the cured resin that fill the winding portions 2A and 2B, and the outer resin portions 6 are the portions of the cured resin that cover the outer core portions 32.

### Effect

According to the above-described reactor manufacturing method, the reactor 1 shown in FIG. 1 can be manufactured. In this reactor 1, due to the resin flowing into the winding portions 2A and 2B, a sufficient amount of resin fills the winding portions 2A and 2B, and a large void is not likely to be formed in the inner resin portions 5 formed in the winding portions 2A and 2B.

Also, in the reactor manufacturing method of the present example, the inner resin portion 5 and the outer resin portion 6 are formed in one piece, and the filling step and the curing step need only be performed once each, and therefore the reactor 1 can be manufactured with good productivity.

### Second Embodiment

The reactor 1 of the first embodiment may also be accommodated in the case and be embedded in the case using potting resin. For example, the second set produced in the attachment step according to the reactor manufacturing method of the first embodiment is accommodated in the case, and the potting resin fills the case. In this case, the potting resin covering the outer peripheries of the outer core portions 32 is the outer resin portions 6. Also, the potting resin that has flowed into the winding portions 2A and 2B is the inner resin portions 5.

### Third Embodiment

The inner resin portions 5 and the second resin portions 6 of the first and second embodiments may also not be included. For example, the reactor 1 may also be completed by producing the first set of the coil 2, the magnetic core 3, and the interposed members 4 and integrating the first set with a band or the like. When the reactor 1 of the present example is immersed in a cooling medium, the cooling medium enters the winding portions 2A and 2B through the gaps between the turns of the winding portions 2A and 2B, and the inner core portions 31 are cooled. In this case, the core through holes 31h do not merely function as gaps, but function also as paths through which the coolant passes, and thus the inner core portion 31 can be cooled effectively.

1. A reactor comprising:
a coil including winding portions; and
a magnetic core including inner core portions arranged inside of the winding portions and outer core portions arranged outside of the winding portions,
wherein the inner core portions are integrated objects with non-divided structures and include core through holes formed in a direction orthogonal to an axial direction of the winding portions,
openings on one side and openings on another side of the core through holes are both closed by the winding portions,
the core through holes each have an inner peripheral surface shape that is uniform in an axial direction of the core through hole,
a maximum width of each core through hole in a core width direction orthogonal to both the axial direction of the winding portion and the axial direction of the core through hole is 0.1 times or more and 0.7 times or less a width of the inner core portion in the core width direction,
the inner peripheral surface shapes are elongated hole shapes that extend in the core width direction, and
intermediate portions in the core width direction of the inner peripheral surface shapes have constricted shapes.

2. (canceled)

3. (canceled)

4. (canceled)

5. The reactor according to claim 1, further comprising:
inner resin portions filling spaces between the winding portions and the inner core portions,
wherein the inner resin portions enter the core through holes.

6. The reactor according to claim 5, comprising outer resin portions that cover at least part of the outer core portions and are connected to the inner resin portions.

7. The reactor according to claim 1, wherein the relative permeability of the inner core portions is 5 or more and 50 or less, and
the relative permeability of the outer core portions is 50 or more and 500 or less, and is greater than the relative permeability of the inner core portions.

8. The reactor according to claim 7, wherein
the inner core portions are constituted by molded bodies of a composite material including a soft magnetic powder and resin.

9. The reactor according to claim 7, wherein the outer core portions are constituted by compressed powder molded bodies of a soft magnetic powder.

10. The reactor according to claim 7, wherein in a plan view of the magnetic core from above, when a ring-shaped virtual magnetic circuit including central axes of the inner core portions and analogous lines that pass through the centers of gravity of the outer core portions and are connected to the central axes, drawing shapes that are similar to outer boundary lines of the outer core portions, is defined, the percentage that the lengths of the central axes occupy in the length of the virtual magnetic circuit is 50% or less.

11. The reactor according to claim 5, wherein the relative permeability of the inner core portions is 5 or more and 50 or less, and
the relative permeability of the outer core portions is 50 or more and 500 or less, and is greater than the relative permeability of the inner core portions.

12. The reactor according to claim 6, wherein the relative permeability of the inner core portions is 5 or more and 50 or less, and
the relative permeability of the outer core portions is 50 or more and 500 or less, and is greater than the relative permeability of the inner core portions.

13. The reactor according to claim 8, wherein in a plan view of the magnetic core from above, when a ring-shaped virtual magnetic circuit including central axes of the inner core portions and analogous lines that pass through the centers of gravity of the outer core portions and are connected to the central axes, drawing shapes that are similar to outer boundary lines of the outer core portions, is defined, the percentage that the lengths of the central axes occupy in the length of the virtual magnetic circuit is 50% or less.

14. The reactor according to claim 9, wherein in a plan view of the magnetic core from above, when a ring-shaped virtual magnetic circuit including central axes of the inner core portions and analogous lines that pass through the centers of gravity of the outer core portions and are connected to the central axes, drawing shapes that are similar to outer boundary lines of the outer core portions, is defined, the percentage that the lengths of the central axes occupy in the length of the virtual magnetic circuit is 50% or less.
